(19) United States
(12) Patent Application Publication
(10) Pub. No.: US 2023/0298221 A1
(43) Pub. Date: Sep. 21, 2023

(54) METHOD AND SYSTEM FOR CONTROLLING ACCESS TO VIRTUAL AND REAL-WORLD ENVIRONMENTS FOR HEAD MOUNTED DEVICE

(71) Applicant: ZEALITY INC., Pleasanton, CA (US)

(72) Inventors: Dipak Mahendra Patel, Selvante St, CA (US); Avram Maxwell Horowitz, San Francisco, CA (US); Karla Celina Varela-Huezo, San Francisco, CA (US)

(21) Appl. No.: 17/654,815

(22) Filed: Mar. 15, 2022

(51) Int. Cl. G06T 11/00; G06T 7/70; G06F 3/01

(52) U.S. Cl. CPC G06T 11/00; G06T 7/70; G06F 3/011

(57) ABSTRACT

A method and processing unit for controlling access to virtual environment and real-world environment for extended reality device are described. The method includes receiving parameters comprising at least one of content data, historic user behavior data, user movement data, and user commands data, in real-time, during display of virtual environment to user wearing extended reality device. Further, intent of one or more users associated with virtual environment is identified, to access real-world environment, based on parameters. Upon identified intent, display of virtual environment and selected view of real-world environment is enabled simultaneously on display screen of extended reality device, based on intent, to control access to virtual environment and selected view of real-world environment. By controlling the access in such manner, user is provisioned with display of real-world environment without interfering with virtual environment. Also, such display is provided in automated manner, without human intervention and additional trigger from user.

### FIELD OF THE PRESENT DISCLOSURE

Embodiments of the present invention generally relate to extended reality systems. In particular, embodiments of the present invention relate to a method and system for controlling access to virtual and real-world environment for a head mounted device presenting extended reality experience to a user.

### BACKGROUND OF THE DISCLOSURE

Extended reality is an experience that includes real-world and/virtual world environment. Such environment replicates real-world or be completely different from the real-world. The extended reality may be a Virtual Reality (VR), Augmented Reality (AR) and Mixed Reality (MR). VR may provide a virtual experience to a user, in form of sight, touch, audio and so on. VR replicates an environment that simulates a physical presence of places in the real world. AR is an overlay of computer generated content on the real world. Using AR, the real world is enhanced with digital objects. MR is a virtual world combined with real-world. The user in MR can interact with both the real-world and virtual environment. Wearable such as glasses and Head-mounted Devices (HMDs), wearable by users, aid to provide such experiences.

Users experiencing extended reality, may be rendered with content of both virtual environment and physical/real-world environment. A switch function may be enabled to switch between the virtual and real-world environment. In some cases, the switch function may be manually selected by the user. In some cases, HMDs may be configured to detect predefined triggers which aid in performing the switching between the virtual and real-world environment. However, such switching may tend to interfere with user's experience with VR. User may consciously enable the switch function to switch from the virtual environment to real-world environment or the real-world to the virtual environment.

Therefore, there is a need for a system which provides user friendly system that efficiently identifies intention of a user to access the real-world environment when viewing the virtual environment.

The information disclosed in this background of the disclosure section is only for enhancement of understanding of the general background of the disclosure and should not be taken as an acknowledgement or any form of suggestion that this information forms existing information already known to a person skilled in the art.

### BRIEF SUMMARY OF THE DISCLOSURE

A method and a processing unit for controlling access to virtual environment and real-world environment for in an extended reality environment are described. The method includes receiving one or more parameters comprising at least one of content data, historic user behavior data, user movement data, and user commands data, in real-time, during display of virtual environment to a user wearing a extended reality device. Further, intent of one or more users associated with the virtual environment is identified, to access real-world environment, based on the one or more parameters. Upon identified the intent, display of the virtual environment and one or more selected views of the real-world environment is enabled simultaneously on display screen of the extended reality device, based on the intent, to control access to the virtual environment and one or more selected views of the real-world environment.

In an embodiment, identifying the intent of the one or more users, further comprises correlating, by the processing unit, the one or more parameters, and identifying the intent of the user to interact with at-least one real-word object in the real-world environment, based on the correlation.

In an embodiment, enabling the display of the virtual environment and the real-world environment comprises displaying the at least one real-world object as the real-world environment in the display screen of the extended reality device.

In an embodiment, displaying the at least one real-world object comprises integrating a sensor system in the extended reality device to detect location of the at least one real-world object in the real-world environment, computing set of coordinates related to the real-world object in the real-world environment and mapping the set of coordinates with a Region of Interest (ROI) on the display screen, to provide real-time display of the at least one real-world object in the ROI.

In an embodiment, displaying the at least one real-world object further comprises controlling the sensor system to enable fixed display of the at least one real-world object in the ROI, irrespective of orientation of the extended reality device.

In an embodiment, enabling the display of the virtual environment and the real-world environment comprises transitioning in a gradient manner, a predetermined portion of the display screen with the virtual environment, to display the real-world environment, wherein remaining portion, other than the predetermined portion, of the display screen displays the virtual environment.

In an embodiment, the content data comprises details of data rendered by the extended reality device to the user.

In an embodiment, the historic user behavior data comprises one or more user actions of the user, relating to accessing the real-world environment, during previous usages of the extended reality device.

In an embodiment, the user movement data comprises at least one of eyeball movement, hand movement and head movement of the user wearing the extended reality device.

In an embodiment, when the one or more users comprise a presenter and one or more attendees in the virtual environment, and the user is one of the one or more attendees, the user command data comprises commands provided by the presenter, in relation to accessing the real-world environment.

The Features and advantages of the subject matter hereof will become more apparent in light of the following detailed description of selected embodiments, as illustrated in the accompanying FIGUREs. As one of ordinary skill in the art will realize, the subject matter disclosed is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an exemplary environment with processing unit for controlling access to virtual environment and real-world environment for an extended reality device, in accordance with an embodiment of the present disclosure;

FIG. 2 illustrates a detailed block diagram showing functional modules of a processing unit for controlling access to virtual environment and real-world environment for an extended reality device, in accordance with an embodiment of the present disclosure;

FIGS. 3A and 3B illustrate exemplary embodiments of extended reality device, in accordance with an embodiment of the present disclosure;

FIG. 4 shows an exemplary representation of field of view of a camera coupled with extended reality device, in accordance with an embodiment of the present disclosure;

FIG. 5 shows an exemplary representation of a VR environment displayed in an extended reality device, in accordance with an embodiment of the present disclosure;

FIG. 6 shows exemplary representations of field of views for identifying intent of user, in accordance with an embodiment of the present disclosure;

FIGS. 7A-7E show exemplary representations of displays of extended reality device, in accordance with an embodiment of the present disclosure;

FIG. 8 is an exemplary process of processing unit for controlling access to virtual environment and real-world environment for an extended reality device, in accordance with an embodiment of the present disclosure; and

FIG. 9 illustrates an exemplary computer unit in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, semiconductor memories, such as ROMs, PROMs, random access memories (RAMs), programmable read-only memories (PROMs), erasable PROMs (EPROMs), electrically erasable PROMs (EEPROMs), flash memory or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Embodiments of the present disclosure relate to a method and processing unit for controlling access to virtual environment and real-world environment in an extended reality experience of a user. The proposed method teaches to identify intention of the user to access the real-world environment, when viewing the virtual environment, without the need of predefined triggers from the user. Based on the identified intent and object associated with the intention, display with the virtual environment is automatically switched to display both the virtual environment and the object present in the real-world environment, simultaneously.

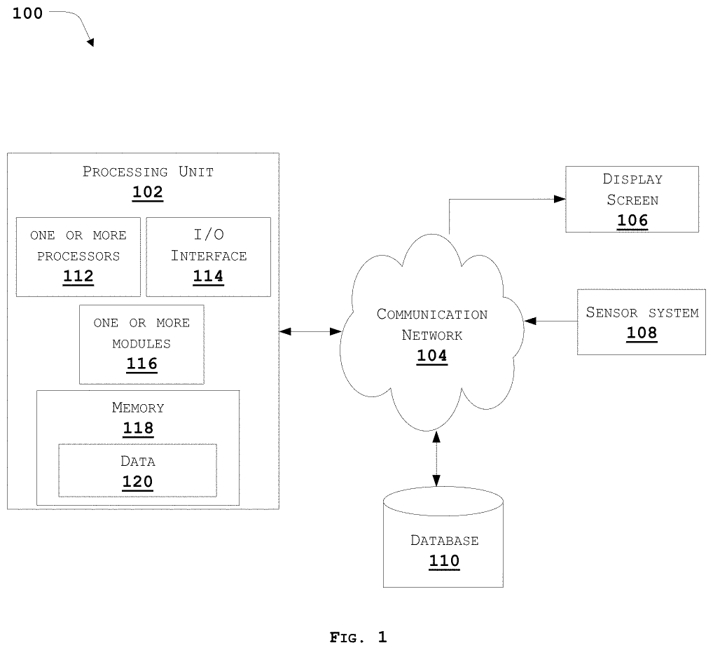

FIG. 1 illustrates an exemplary environment 100 with processing unit for controlling access to virtual environment and real-world environment for an extended reality device, in accordance with an embodiment of the present disclosure. As shown in FIG. 1, the exemplary environment 100 comprises the processing unit 102, a communication network 104, a display screen 106, a sensor system 108 and a database 110. Further, the exemplary environment 100 may be implemented within the extended reality device. Extended reality may be one of VR, AR, MR or any other immersive content rendering technology. In an embodiment, the extended reality device may be a smart glasses or a head mounted device worn by a user to experience the immersive environment. One or more other kinds of wearable, which is capable of rendering content to a user in the extended reality environment, may be implemented as the extended reality device. In an embodiment, part of the exemplary environment may be implemented within the extended reality device. For example, the display screen 106 and the sensor system 108 may be coupled with the extended reality device, whereas the processing unit 102 and the database 110 may be external to the extended reality device and be connected with the extended reality device via a communication means. In an embodiment, the processing unit 102 and the database 110 may wirelessly communicate with the display screen 106 and the sensor system 108 to control access to the virtual environment and the real-world environment. In an embodiment, at least one of the processing unit 102 and the database 110 may be implemented in a dedicated server or a cloud-based server, for communicating with the display screen 106 and the sensory system 108, and thereby control the access to the virtual environment and the real-word environment in extended reality.

The display screen 106 is part of the extended reality device, through which virtual environment may be presented to the user wearing the extended reality device. Content, to be rendered to the user wearing the extended reality device, may be displayed on the display screen 106. Usually, the content may be customized immersive media content. Such content provisions 360° view of a virtual environment to the user. In another embodiment, the content may be a multi-media video or image rendered to the user. In an embodiment, the display screen 106 extends beyond field of view of user to block surrounding ambient to the user. Such display screen offers an immersive virtual environment blocking vision of real-world environment to the user. In an embodiment, virtual environment includes content displayed on the display screen 106 of the extended reality device. The real-world environment may be including real-world objects surrounding the user wearing the extended reality device. In an embodiment, the extended reality environment may be experienced by a single user or plurality of users at an instant of time. The extended reality environment with single user may be such scenarios where a user is viewing a video or taking a virtual tour of a location or is replaying a pre-stored immersive streaming and so on. The extended reality environment with multiple users may be a virtual classroom with a lecturer and one or more students, or a meeting/presentation with a presenter and one or more attendees, or a virtual game with multiple players, a commentator and one or more audience, and the like.

The sensor system 108 includes one or more sensors coupled with the extended reality device. In an embodiment, the one or more sensors are configured to monitor movement of the user wearing the extended reality device. In an embodiment, the one or more sensors are configured to monitor the real-world environment surrounding the user wearing the extended reality device. In an embodiment, the one or more sensors may include, but are not limited to, one or more cameras, tilt sensors, accelerometers, and movement detectors and so on. One or more other sensors, known to a person skilled in the art, which may be used to monitor the movement of the user, may be implemented in the sensor system 108. The one or more sensors may be placed on interior surface or exterior surface of the extended reality device. In an embodiment, the one or more cameras may be placed on the interior surface of the extended reality device and may be configured to detect movement of eyeball of the user. In an embodiment, the one or more cameras may be placed on the exterior surface of the extended reality device and may be configured to capture images and videos of real-world environment surrounding the user. In another embodiment, the one or more cameras placed on the exterior surface of the extended reality device may be configured to detect movement of the user. The movement of the user may include, but is not limited to, hand movement, hand gesture, direction of motion of the user and so on.

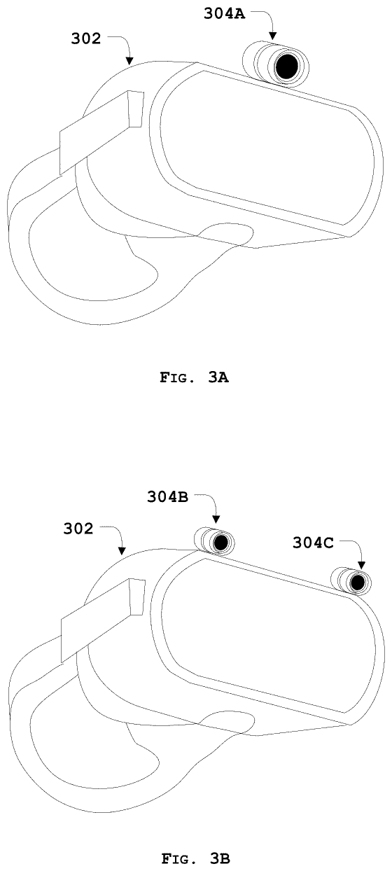

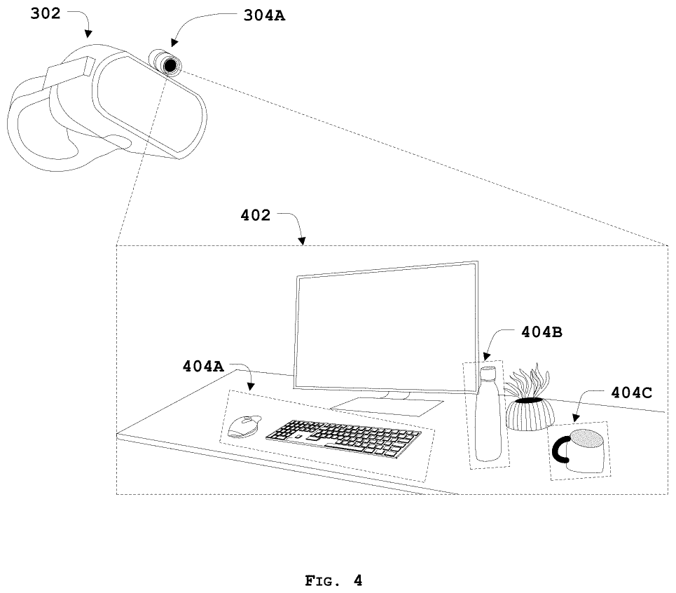

FIGS. 3A and 3B illustrate exemplary embodiments of extended reality device 302 with one or more cameras placed on the exterior surface of the extended reality device, in accordance with an embodiment of the present disclosure. In the illustrated embodiment, the extended reality device 302 is a head mounted device. In an alternate embodiment, the extended reality device 302 may be any device which can render extended reality environment to the user. In an embodiment, as shown in FIG. 3A, the extended reality device may include a single camera 304A mounted on the extended reality device 302. In another embodiment, as shown in FIG. 3B, the extended reality device 302 may include two cameras 304A and 304B mounted on the extended reality device 302. The illustrated embodiments do not restrict on structure of the extended reality device, number of cameras placed on the extended reality devices and placement of the cameras on the extended reality devices. The number of cameras and the placement of the cameras on the extended reality device may vary based on applications and requirements of the user.

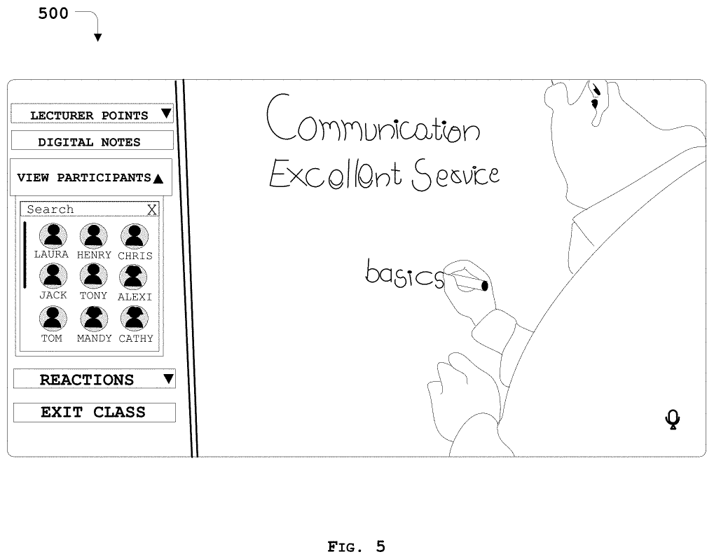

In an embodiment, the number of cameras and placement of the cameras may be based on Field of View (FOV) that is to be covered for controlling the access to the virtual and real-world environment. Consider a scenario where a user is attending a class in a virtual environment using the extended reality device 302. FIG. 4 shows an exemplary representation of FOV 402 of the camera 304A coupled with the extended reality device 302, in accordance with an embodiment of the present disclosure. The FOV 402 covers the front view of the user. In case a broader FOV is required, two or more cameras may be placed on the exterior surface. In case, back view of the user is required, a camera may be placed such that a lens of the cameras faces the back view. In an embodiment, movement of the one or more cameras coupled with the extended reality device 302 may be controlled to capture multiple views in the surroundings of the user.

Further, at least one of other sensors, including, but are not limited to, the tilt sensors, the accelerometers, and the movement detectors and so on, may be configured to detect movement of head of the user. One or more other sensors, known to a person skilled in the art, may be implemented in the extended reality device, for detecting the movement of the head of the user. In some embodiments, the one or more sensors in the sensor system 108 may be interconnected to work in tandem, based on sensed data. In an embodiment, the sensor system 108 may be connected to controllers, drivers and actuators to control operation and movement of the one or more sensors in the sensor system 108. One or more other alternate sensors, known to a person skilled in the art, may be implemented in the sensor system, to detect movement related to the user, and capture the real-world environment.

The database 110 may be a memory unit or a data storage space associated with the extended reality device and the processing unit 102. The database 110 may be configured to store data associated with users of the extended reality device and usage of the extended reality device, in relation to content rendered to the user through the extended reality device. Such data may include user behavior for particular type of the content, user usage pattern of the extended reality device, one or more actions performed by the user and so on. In an embodiment, the processing unit 102 may be configured to log such data for every usage of the extended reality device and store in the database 110 as historic user behavior data. In an embodiment, the database 110 may be associated with single user of the extended reality device and historic user behavior data related to the single user may be store in the database 110. In another embodiment, the database 110 may be configured to log such data for multiple users of the extended reality devices. Historic user behavior data associated with each of the multiple users may be stored in the database 110. In an embodiment, the database 110 may be cloud based database which may be associated with multiple extended reality devices. In such cases historic user behavior data related to each of one or more users of each of the multiple extended reality devices may be stored in the database 110. The historic user behavior data may be collected dynamically, in real-time and stored in the database 110. The historic user behavior data may be retrieved from the database 110, by the processing unit 102, when controlling the access to the virtual environment and the real-world environment. In an embodiment, the database 110 may be integral part of the processing unit 102.

In an embodiment, using at least one camera placed on the exterior surface of the extended reality device, one or more real-world objects may be identified and details of such one or more real-world objects may be stored in the database 110. In an embodiment, the processing unit 102 may be configured to identify the one or more real-world objects based on the historic user behavior data. In an embodiment, details of real-world objects previously used by the user may be determined by the processing unit 102 and stored in the database 110 as the historic user behavior data. In real-time, when the user commences usage of the extended reality device, the at least one camera placed on the exterior surface of the extended reality device may be used to capture images of FOV of the at least one camera to locate at least on real-world object from the previously used real-world objects. One or more image processing techniques and object mapping algorithms may be implemented in the processing unit 102 to identify the at least one real-world object. For example, referring to FIG. 4, from the FOV 402 of the camera 304A, the at least one real-world object may be identified to be keyboard and mouse 404A, a water bottle 404B and a coffee mug 404C. In an alternate embodiment, when the usage of the virtual environment commences, the user may be provisioned to directly feed the details of the at least one real-world objects to the processing unit 102. In a different scenario, the at least one real-world object may vary based on surroundings of the user. For example, consider the user is watching a movie using an extended reality device. At least one real-world object may include phone, snacks, juice can and so on.

The processing unit 102 may include one or more processors 112, an Input/Output (I/O) interface 114, one or more modules 116 and a memory 118. In some non-limiting embodiments or aspects, the memory 118 may be communicatively coupled to the one or more processors 112. The memory 118 stores instructions, executable by the one or more processors 112, which on execution, may cause the processing unit 102 to control the access of the virtual environment and the real-world environment to a user wearing the extended reality device, as described in the present disclosure. In some non-limiting embodiments or aspects, the memory 118 may include data 120. In an embodiment, the database 110 may be part of the memory 118. The one or more modules 116 may be configured to perform the steps of the present disclosure using the data 120 to control the access. In some non-limiting embodiments or aspects, each of the one or more modules 116 may be a hardware unit, which may be outside the memory 118 and coupled with the processing unit 102. In some non-limiting embodiments or aspects, the processing unit 102 may be implemented in a variety of computing systems, such as a laptop computer, a desktop computer, a Personal Computer (PC), a notebook, a smartphone, a tablet, e-book readers, a server, a network server, a cloud server, and the like.

The processing unit 102 may be in communication with at least one of the display screen 106, the sensor system 108 and the database 110. In some non-limiting embodiments or aspects, the processing unit 102 may communicate with at least one of the display screen 106, the sensor system 108 and the database 110 via a communication network 104. The communication network 104 may include, without limitation, a direct interconnection, a Local Area Network (LAN), a Wide Area Network (WAN), a wireless network (e.g., using Wireless Application Protocol), the Internet, and the like. In some non-limiting embodiments or aspects, a dedicated communication network may be implemented to establish communication between the processing unit 102 and each of the display screen 106, the sensor system 108 and the database 110.

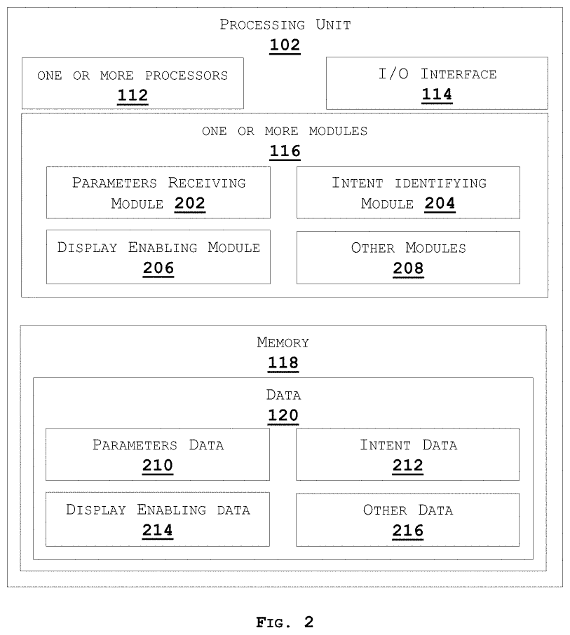

FIG. 2 shows a detailed block diagram of the processing unit 102 for controlling access to the virtual environment and the real-world environment, in accordance with some non-limiting embodiments or aspects of the present disclosure. The data 120 in the memory 118, and the one or more modules 116 of the processing unit 102 are described herein in detail. In one implementation, the one or more modules 116 may include, but is not limited to, a parameters receiving module 202, an intent identifying module 204, a display enabling module 206, and one or more other modules 208 associated with the processing unit 102. In some non-limiting embodiments or aspects, the data 120 in the memory 118 may include parameters data 210 (herewith also referred to as one or more parameters 210), intent data 212 (herewith also referred to as intent 212), display enabling data 214, and other data 216 associated with the processing unit 102.

In some non-limiting embodiments or aspects, the data 120 in the memory 118 may be processed by the one or more modules 116 of the processing unit 102. In some non-limiting embodiments or aspects, the one or more modules 116 may be implemented as dedicated units and when implemented in such a manner, the modules may be configured with the functionality defined in the present disclosure to result in a novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 116 of the present disclosure function to control the access to the virtual and real-world environment. The one or more modules 116 along with the data 120, may be implemented in any system for the controlling.

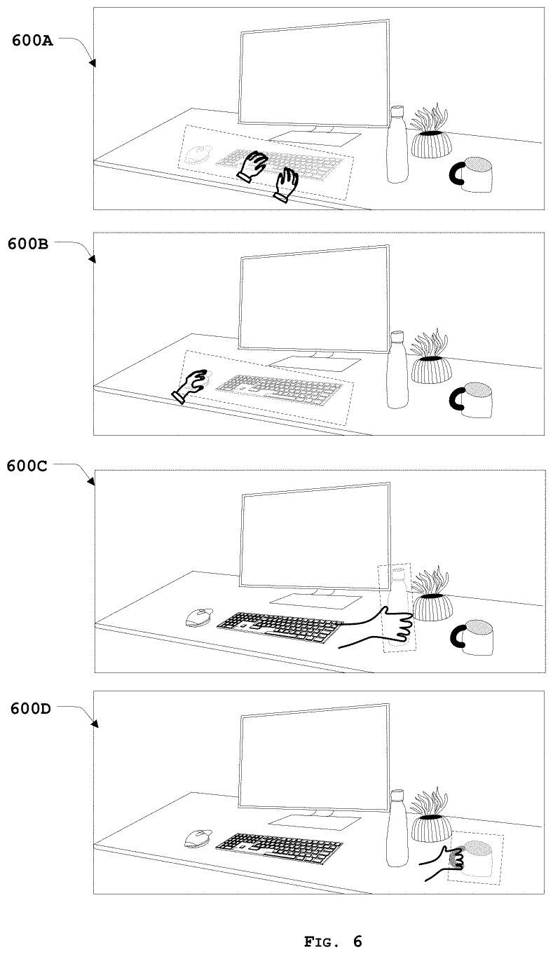

Initially, for controlling the access to the virtual environment and the real-world environment, the parameters receiving module 202 may be configured to receive one or more parameters 210 comprising at least one of content data, the historic user behavior data, the user movement data, and the user commands data. One or more other data related to the rendered content and the user may be received as the one or more parameters 210. In an embodiment, the one or more parameters 210 may be received real-time during display of a virtual environment to the user. Consider the VR environment is a virtual classroom. FIG. 5 shows an exemplary representation of the VR environment 500 displayed in an extended reality device, in accordance with an embodiment of the present disclosure. The illustrated VR environment is a classroom environment, where the user is a student wherein the extended reality device. The VR environment 500 includes a lecturer lecturing on a topic. The VR environment may include an interactive interface where one or more users may interact and provide inputs in the VR environment. For example, in the virtual classroom scenario, the one or more users are the lecturer and students. The virtual environment 500 is a display provided to a student. The interactive interface may include multiple options for the student to select. The multiple options may include, but is not limited to, view lecturer points, take down digital notes, view participant of the virtual class, provide reactions to the virtual class, exit the virtual class and so on.

Further, the content data from the one or more parameters 210 may comprise details of data rendered by the extended reality device to the user. In some embodiments, the content data may be predefined by the user with temporal stamping and spatial stamping. Such predefined content data may be stored in the memory 118 as the parameters data and retrieved in real-time, when displaying the virtual environment. In an alternate embodiment, at the time of display of the virtual environment, the user may be provisioned to provide details of the content displayed on the display of the extended reality device. Such details may be received as the content data and stored in the memory 118 as the parameters data. Simultaneously, such content data may be used for controlling the access to the virtual and real-world environment. For the virtual environment 500 illustrated in FIG. 5, the content data may include topics to be lectured by the lecturer, data (diagrams/figures/text/videos) displayed during the lecture, annotations of the lecture and so on. In an embodiment, the content data may also include time duration of each of the topics, time stamps and spatial stamps of the data and the annotations to be displayed and so on. In an embodiment, the parameters receive module may be pre-fed with the content data. In another embodiment, the lecturer may dynamically feed the content data during the lecture.

Further, the historic user behavior data in the one or more parameters 210 may comprise one or more user actions of the user. The one or more user actions may relate to accessing the real-world environment during previous usages of the extended reality device. In an embodiment, the one or more user actions may be monitored and stored in the database associated with the extended reality device, for every usage of the extended reality device. As described previously, the historic user behavior data may be retrieved from the database associated with the extended reality device. Such retrieved data may be stored as the parameters data 210. Consider the virtual environment is a virtual classroom. In such case, the user behavior may include actions of accessing real-world environment to reach out to the real-world objects. For example, some of the users may access the keyboard as soon as the virtual class commences, to take notes in digital notepad. Some of the users may have a habit to grab a coffee mug after one hour of class. Said user behaviors and other such user behaviors which include accessing the real-world objects may be recorded and stored in the database.

The user movement data comprises at least one of eyeball movement, hand movement and head movement of the user wearing the extended reality device. The user movement data may be received from the sensor system, in real-time. For example, the camera placed on interior surface of the extended reality device may be configured to monitor eyeball movement of the user. In an embodiment, images or video of eyes of the user is captured continuously or at regular intervals of time. The captured images and video is analyzed to detect the eyeball movement. In an embodiment, the processing unit 102 may be configured to analyze the images or frames of the video to detect the eyeball movement. In an embodiment, the images and the video is further analyzed to check if direction of the movement of the eyeball is toward the location of at least one real-world object. When the eyeball movement is detected to be towards the location of the at least one real-world object, such detection is received as the user movement data and stored as the one or more parameters 210 in the memory 118. Similarly, the camera placed on the exterior surface of the extended reality device may be configured to monitor hand movement of the user. In an embodiment, images or video of front view of the user is captured continuously or at regular intervals of time. The captured images and video is analyzed to detect presence of hand and location of detected hand in the FOV of the camera. In an embodiment, the processing unit 102 may be configured to analyze the images or frames of the video to detect the hand movement. In an embodiment, the images and the video is analyzed to check if direction of the movement of the hand is towards the location of at least one real-world object. When the hand movement is detected to be towards the location of the at least one real-world object, such detection is received as the user movement data and stored as the one or more parameters 210 in the memory 118.

Further, the one or more parameters 210 include user command data. Consider a scenario where the virtual environment include multiple users. Commands relating to accessing real-world object during display of the virtual environment may be considered to the user command data. Such commands may be provided by a user from the multiple users. For example, consider the virtual environment is a virtual classroom with a lecturer and student. During the class, the lecturer may instruct to make a note for a point that was explained. Making a note may require the student to access the keyboard, or a book and pen in front of the student. Thus, such instruction may be received and stored to be the user command data. Consider another scenario where the virtual environment is a virtual gaming environment with multiple players. One or more players instructs to grab an artificial weapon during the game. Such instruction may require the user to access the artificial weapon placed in front. Thus, such instruction may be received and stored to be the user command data. In an embodiment, the commands may be in form of voice commands, or may be indicated via text. In an embodiment, such commands may be pre-defined and auto-generated by the extended reality device.

Upon receiving the one or more parameters 210, the intent identifying module 204 may be configured to identify intent 212 of one or more users associated with the virtual environment. Need to provide access to the real-world environment may vary based on intent 212 of the user in the virtual environment. For example, in a virtual environment with a single user, the single user may intent to grab a snack when taking a virtual tour, or may have a need to attend a phone call when viewing a video in an immersive environment and so on. Similarly, consider the virtual environment is a virtual classroom with multiple users. There may be a need to a user from the multiple users to take digital notes by typing on keyboard in real-world environment, or there may be a need to the user to take notes on a physical notepad with a pen. The intent identifying module 204 may be configured to identify the intent 212 of the one or more users to access the real-world environment. The intent 212 may be identified based on the one or more parameters 210.

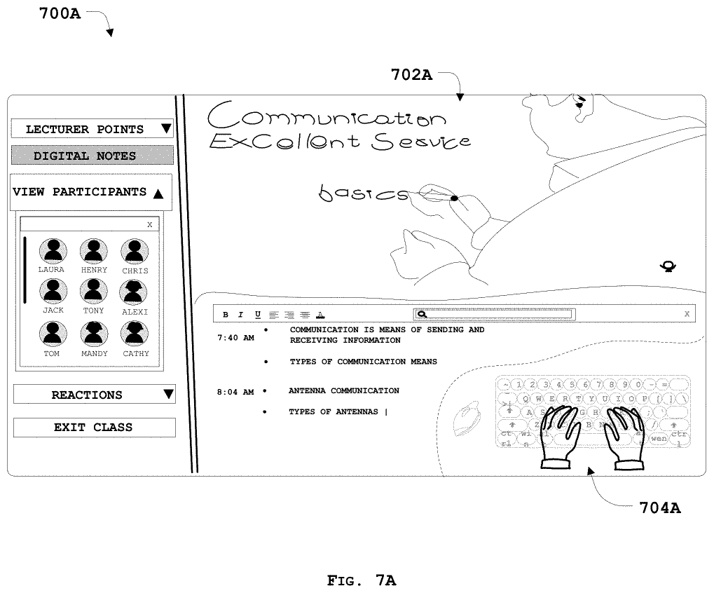

In an embodiment, the intent 212 may be identified by correlating the one or more parameters 210. At least one of the content data, the historic user behavior data, user movement data, and the user commands data are correlated with each other to identify the intent 212 of the user. For example, consider FOVs 600A and 600B (as shown in FIG. 6) captured by a camera placed on the exterior surface of the extended reality device. When a command to take notes is provided by a presenter in the virtual environment and simultaneously hand movement of an attendee is detected as shown in FOVs 600A and 600B, the intent 212 may be identifying that the attendee is trying to access the keyboard and mouse in the real-world environment. Similarly, when the user selects the option of opening digital notes and simultaneously hand movement of user is detected as shown in FOVs 600A and 600B, the intent 212 may be identifying that the user is trying to access the keyboard and mouse in the real-world environment. Similarly, consider a user is detected to have a habit to make a phone call during an interval of a virtual game using the historic user behavior data. Further, an interval of a game is detected using the content data. In such case, as soon as the interval of the game is detected and when eyeball movement of the user is detected to be in direction of mobile phone placed in front of the user, the intent 212 may be identified to be that user is trying to reach out the mobile phone in the real-world environment. The intent identifying module 204 may be configured to perform the correlation between the content data, the historic user behavior data, user movement data, and the user commands data, using one or more correlation analysis techniques known to a person skilled in the art. In an embodiment, the intent identifying module 204 may implement learning models to perform the correlation.

In an embodiment, the intent 212 may be identified using one of the content data, the historic user behavior data, user movement data, and the user commands data. For example, consider FOVs 600C and 600D shown in FIG. 6, captured by camera placed on the exterior surface of the extended reality device. Mere hand movement of the user may be detected. Using the detected hand movement, the intent may be identified to be that the user is trying to grab a water bottle and coffee mug.

Upon identifying the intent 212, the display enabling module 206 may be configured to enable display of the virtual environment and one or more selected views of the real-world environment, simultaneously, on display screen of the extended reality device. The display may be enabled based on the intent 212. In an embodiment, the display of the virtual environment and the real-world environment may be enabled by displaying the at least one real-world object as the real-world environment in the display screen of the extended reality device. The one or more selected views may include the location of the real-world object associated with the intent 212. In an embodiment, the virtual environment and the real-world environment are displayed simultaneously by transitioning, in a gradient manner, a predetermined portion of the display screen with the virtual environment, to display the real-world environment, wherein remaining portion, other than the predetermined portion, of the display screen displays the virtual environment.

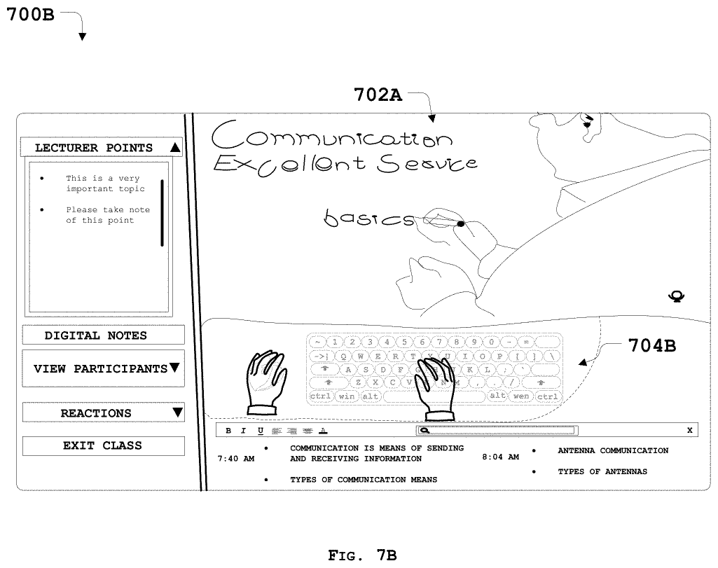

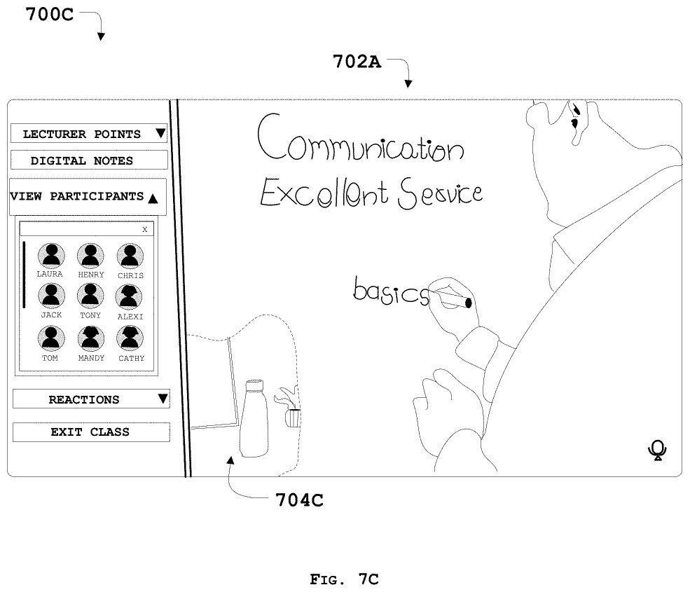

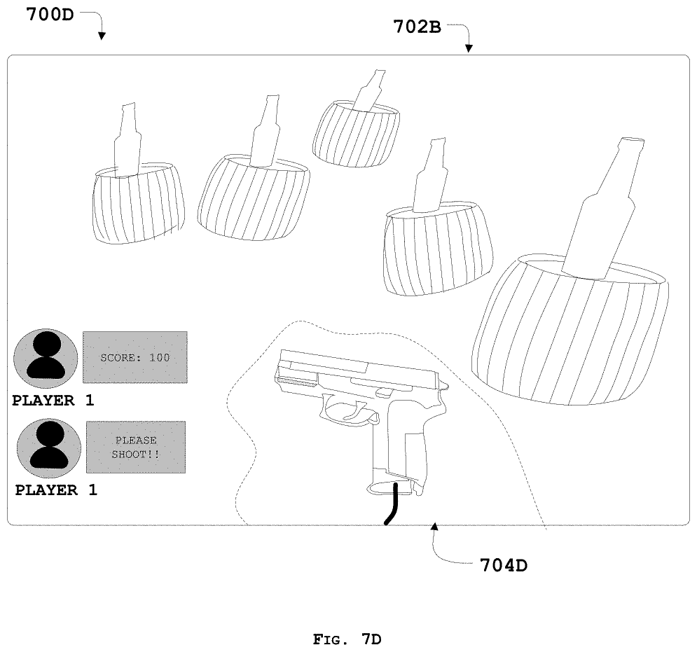

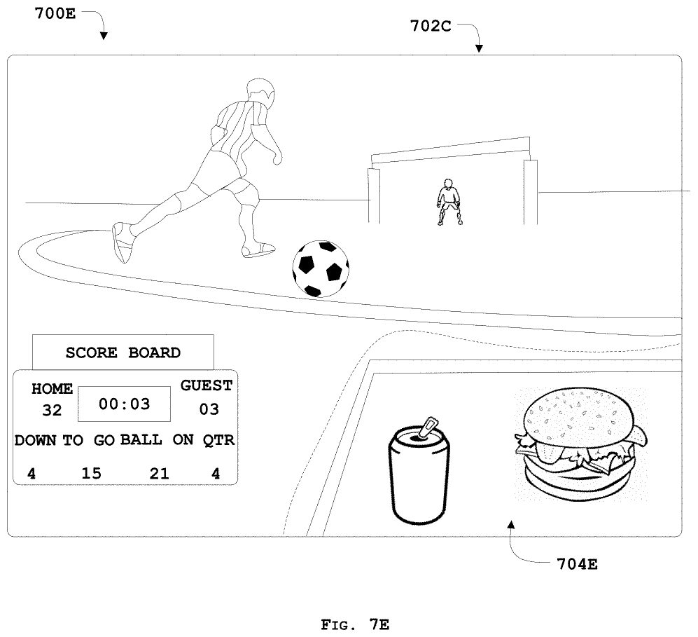

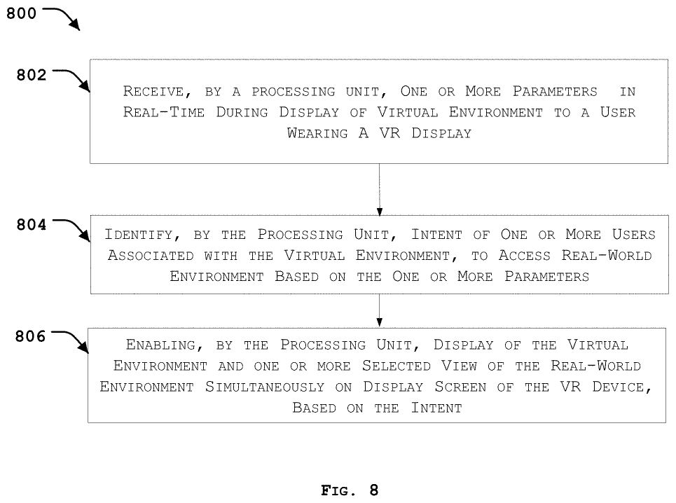

Consider in a virtual classroom, the user selecting the option to open digital notes and hand movement towards the keyboard is detection. In such case, keyboard and the mouse may be detected to be the at least one real-world object. Thus, an exemplary representation of display 700A as shown in FIG. 7A may be displayed on the display screen of the extended reality device worn by the user. A predetermined portion 704A may be selected to display the real-world environment with the keyboard and the mouse.

Consider presenter provides commands in form of written notes to take notes and simultaneously, hand movement towards the keyboard is detection. In such case, keyboard and the mouse may be detected to be the at least one real-world object. Thus, an exemplary representation of display 700B as shown in FIG. 7B may be displayed on the display screen of the extended reality device worn by the user. A predetermined portion 704B may be selected to display the real-world environment with the keyboard and the mouse.

Consider hand movement of the user is detected to be towards the water bottle. In such case, the water bottle may be detected to be the at least one real-world object. Thus, an exemplary representation of display 700C as shown in FIG. 7C may be displayed on the display screen of the extended reality device worn by the user. A predetermined portion 704C may be selected to display the real-world environment with the keyboard and the mouse.

Consider the extended reality is a gaming environment with multiple players i.e., Player 1 and Player 2. An exemplary representation of display 700B as shown in FIG. 7D may be displayed on the display screen of the extended reality device worn by the user. Consider the user is Player 2. When it is the turn of the user to shoot the bottle, the user may engage the weapon by accessing the artificial gun placed in front of the user. Based on the user behavior data, the intent may be identified to be accessing the artificial gun when turn to shoot is of Player 2. A predetermined portion 704D may be selected to display the real-world environment with the artificial gun.

Consider the extended reality is a virtual display of a football game. The football game is viewed by the user using the extended reality device. At least one real-world object may be fed by the user, when commencing the football game. Consider the at least one real-world object include a burger and a juice can placed in front of the user. In one scenario, when movement of the user is detected to reach out to the burger and the juice can, an exemplary representation of display 700C, as shown in FIG. 7E, may be displayed on the display screen of the extended reality device worn by the user. A predetermined portion 704E may be selected to display the real-world environment with the burger and juice can.

In an embodiment, set of coordinates related to the real-world object in the real-world environment may be computed by the processing unit 102. The set of coordinates are mapped with a Region of Interest (ROI) on the display screen, to provide real-time display of the at least one real-world object in the ROI. The ROI may be the predetermined portion on the display screen. In an embodiment, the ROI may be predefined by the user of the extended reality device. In an embodiment, the ROI may be static for all the extended reality devices and all the users. In an embodiment, the ROI on the display may dynamically change based on actual location of the at least one real-world object. For example, when the actual location of the at least one real-world object is towards left side, the ROI may be towards the left side of the display. This may help the user to easily locate the at least real-world object by viewing on the display of the extended reality device. In an embodiment, the at least one real-world object may be displayed by controlling the sensor system to enable fixed display of the at least one real-world object in the ROI, irrespective of orientation of the extended reality device. The camera placed on the exterior surface may be rotatable, such that, even when the head orientation of the user changes, the camera may be actuated to keep the at least one real-word object within its FOV. In an embodiment, data related to the real-world environment to be displayed along with the virtual environment, may be stored as the display enabling data 214 in the memory 118. In an embodiment, the display enabling data 214 may include set of coordinates from the real-world environment.

In some non-limiting embodiments or aspects, the processing unit 102 may receive data for controlling the access to the virtual and real-world environment via the I/O interface 114. The received data may include, but is not limited to, at least one of the content data, the historic user behavior data, the user command data, the user movement data, and the like. Also, the processing unit 102 may transmit data for controlling the access to the virtual and real-world environment via the I/O interface 114. The transmitted data may include, but is not limited to, the intent data, display enabling data and the like.

The other data 216 may comprise data, including temporary data and temporary files, generated by modules for performing the various functions of the processing unit 102. The one or more modules may also include other modules 208 to perform various miscellaneous functionalities of the processing unit 102. It will be appreciated that such modules may be represented as a single module or a combination of different modules

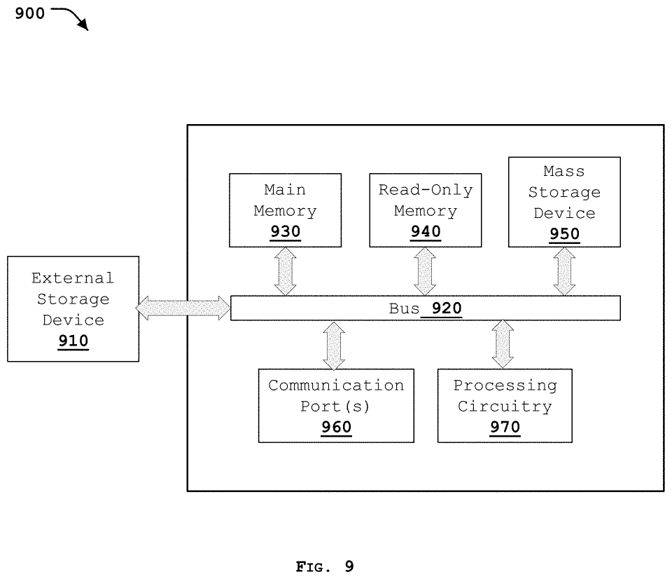

FIG. 8 shows an exemplary process of processing unit for controlling access to virtual environment and real-world environment for an extended reality device redundant braking in a remotely piloted vehicle, in accordance with an embodiment of the present disclosure. Process 800 for controlling access to the virtual environment and the real-world environment includes steps coded in form of executable instructions to be executed by a processing unit associated with the extended reality device.

At block 802, the processing unit is configured to receive one or more parameters in real-time, during display of virtual environment to a user wearing an extended reality device. The one or more parameters include, but are not limited to, at least one of content data, historic user behavior data, user movement data, and user commands data.

At block 804, the processing unit is configured to identify intent of one or more users associated with the virtual environment, to access real-world environment, based on the one or more parameters.

At block 804, the processing unit is configured to enable display of the virtual environment and one or more selected views of the real-world environment simultaneously on display screen of the extended reality device, based on the intent, to control access to the virtual environment and one or more selected views of the real-world environment.

FIG. 9 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 9, the computer system 900 includes an external storage device 910, bus 920, main memory 930, read-only memory 940, mass storage device 950, communication port(s) 960, and processing circuitry 970.

Those skilled in the art will appreciate that the computer system 900 may include more than one processing circuitry 970 and one or more communication ports 960. The processing circuitry 970 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quadcore, Hexa-core, or any suitable number of cores) or supercomputer. In some embodiments, the processing circuitry 970 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 970 include, but are not limited to, an Intel® Itanium® or Itanium 2 processor(s), or AMD® Opteron® or Athlon MP® processor(s), Motorola® lines of processors, System on Chip (SoC) processors or other future processors. The processing circuitry 970 may include various modules associated with embodiments of the present disclosure.

The communication port 960 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 960 may be any RS-232 port for use with a modem-based dialup connection, a 10/100 Ethernet port, a Gigabit, or a 10 Gigabit port using copper or fiber, a serial port, a parallel port, or other existing or future ports. The communication port 960 may be chosen depending on a network, such as a Local Area Network (LAN), Wide Area Network (WAN), or any network to which the computer system 900 may be connected.

The main memory 930 may include Random Access Memory (RAM) or any other dynamic storage device commonly known in the art. Read-only memory (ROM) 940 may be any static storage device(s), e.g., but not limited to, a Programmable Read-Only Memory (PROM) chips for storing static information, e.g., start-up or BIOS instructions for the processing circuitry 970.

The mass storage device 950 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 930. The mass storage device 950 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 920 communicatively couples the processing circuitry 970 with the other memory, storage, and communication blocks. The bus 920 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 970 to the software system.

Optionally, operator and administrative interfaces, e.g., a display, keyboard, and a cursor control device, may also be coupled to the bus 920 to support direct operator interaction with the computer system 900. Other operator and administrative interfaces may be provided through network connections connected through the communication port(s) 960. The external storage device 910 may be any kind of external hard drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The computer system 900 may be accessed through a user interface. The user interface application may be implemented using any suitable architecture. For example, it may be a stand-alone application wholly implemented on the computer system 900. The user interfaces application and/or any instructions for performing any of the embodiments discussed herein may be encoded on computer-readable media. Computer-readable media includes any media capable of storing data. In some embodiments, the user interface application is a client-server-based application. Data for use by a thick or thin client implemented on electronic device computer system 900 is retrieved on-demand by issuing requests to a server remote to the computer system 900. For example, computer system 900 may receive inputs from the user via an input interface and transmit those inputs to the remote server for processing and generating the corresponding outputs. The generated output is then transmitted to the computer system 900 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

We claim:

1. A method for controlling access to virtual environment and real-world environment in an extended reality environment, the method comprising:
receiving, by a processing unit, one or more parameters comprising at least one of content data, historic user behavior data, user movement data, and user commands data, in real-time, during display of virtual environment to a user wearing an extended reality device;
identifying, by the processing unit, intent of one or more users associated with the virtual environment, to access real-world environment, based on the one or more parameters;
enabling, by the processing unit, display of the virtual environment and one or more selected views of the real-world environment simultaneously on display screen of the extended reality device, based on the intent, to control access to the
virtual environment and one or more selected views of the real-world environment.

2. The method of claim 1, wherein identifying the intent of the one or more users, further comprises:
correlating, by the processing unit, the one or more parameters; and
identifying, by the processing unit, the intent of the user to interact with at-least one real-word object in the real-world environment, based on the correlation.

3. The method of claim 2, wherein enabling the display of the virtual environment and the real-world environment, comprises:
displaying, by the processing unit, the at least one real-world object as the real-world environment in the display screen of the extended reality device.

4. The method of claim 3, wherein displaying the at least one real-world object comprises:
integrating, by the processing unit, a sensor system in the extended reality device to detect location of the at least one real-world object in the real-world environment;
computing, by the processing unit, set of coordinates related to the real-world object in the real-world environment; and
mapping, by the processing unit, the set of coordinates with a Region of Interest (ROI) on the display screen, to provide real-time display of the at least one real-world object in the ROI.

5. The method of claim 4, wherein displaying the at least one real-world object further comprises:
controlling the sensor system to enable fixed display of the at least one real-world object in the ROI, irrespective of orientation of the extended reality device.

6. The method of claim 1, wherein enabling the display of the virtual environment and the real-world environment, comprises:
transitioning, by the processing unit, in a gradient manner, a predetermined portion of the display screen with the virtual environment, to display the real-world environment, wherein remaining portion, other than the predetermined portion, of the display screen displays the virtual environment.

7. The method of claim 1, wherein the content data comprises details of data rendered by the extended reality device to the user.

8. The method of claim 1, wherein the historic user behavior data comprises one or more user actions of the user, relating to accessing the real-world environment, during previous usages of the extended reality device.

9. The method of claim 1, wherein the user movement data comprises at least one of eyeball movement, hand movement and head movement of the user wearing the extended reality device.

10. The method of claim 1, wherein, when the one or more users comprise a presenter and one or more attendees in the virtual environment, and the user is one of the one or more attendees, the user command data comprises commands provided by the presenter, in relation to accessing the real-world environment.

11. A processing unit for controlling access to virtual environment and real-world environment in an extended reality environment, the processing unit comprises:
one or more processors; and
a memory communicatively coupled to the one or more processors, wherein the memory stores processor-executable instructions, which, on execution, cause the one or more processors to:
receive one or more parameters comprises at least one of content data, historic user behavior data, user movement data, and user commands data, in real-time, during display of virtual environment to a user wearing an extended reality device;
identify intent of one or more users associated with the virtual environment, to access real-world environment, based on the one or more parameters;
enable display of the virtual environment and one or more selected views of the real-world environment simultaneously on display screen of the extended reality device, based on the intent, to control access to the virtual environment and one or more selected views of the real-world environment.

12. The processing unit of claim 11, wherein the one or more processors are configured to identify the intent of the one or more users, by:
Correlating the one or more parameters; and
identifying the intent of the user to interact with at-least one real-word object in the real-world environment, based on the correlation.

13. The processing unit of claim 12, wherein the one or more processors are configured to enable the display of the virtual environment and the real-world environment, by:
displaying the at least one real-world object as the real-world environment in the display screen of the extended reality device.

14. The processing unit of claim 13, wherein the one or more processors are configured to display the at least one real-world object by:
integrating a sensor system in the extended reality device to detect location of the at least one real-world object in the real-world environment;
computing set of coordinates related to the real-world object in the real-world environment; and
mapping the set of coordinates with a Region of Interest (ROI) on the display screen, to provide real-time display of the at least one real-world object in the ROI.

15. The processing unit of claim 14, wherein the one or more processors are configured to display the at least one real-world object by:
controlling the sensor system to enable fixed display of the at least one real-world object in the ROI, irrespective of orientation of the extended reality device.

16. The processing unit of claim 11, wherein the one or more processors are configured to enable the display of the virtual environment and the real-world environment, by:
Transitioning in a gradient manner, a predetermined portion of the display screen with the virtual environment, to display the real-world environment, wherein remaining portion, other than the predetermined portion, of the display screen displays the virtual environment.

17. The processing unit of claim 11, wherein the content data comprises details of data rendered by the extended reality device to the user.

18. The processing unit of claim 11, wherein the historic user behavior data comprises one or more user actions of the user, relating to accessing the real-world environment, during previous usages of the extended reality device.

19. The processing unit of claim 11, wherein the user movement data comprises at least one of eyeball movement, hand movement and head movement of the user wearing the extended reality device.

20. The processing unit of claim 11, wherein, when the one or more users comprise a presenter and one or more attendees in the virtual environment, and the user is one of the one or more attendees, the user command data comprises commands provided by the presenter, in relation to accessing the real-world environment.
